(19) United States
(12) Patent Application Publication
(10) Pub. No.: US 2025/0193351 A1
(43) Pub. Date: Jun. 12, 2025

(54) CONTROL METHOD, PROJECTOR, AND NON-TRANSITORY COMPUTER-READABLE STORAGE MEDIUM

(71) Applicant: SEIKO EPSON CORPORATION, Tokyo (JP)

(72) Inventors: Shinji Kubota, Ina-shi (JP); Yuki Mori, Matsumoto-shi (JP); Shiki Furui, Matsumoto-shi (JP); Kota Takeuchi, Azumino-shi (JP)

(73) Assignee: SEIKO EPSON CORPORATION, Tokyo (JP)

(21) Appl. No.: 18/971,318

(22) Filed: Dec. 6, 2024

(30) Foreign Application Priority Data
Dec. 8, 2023 (JP) 2023-207535

(51) Int. Cl. H04N 9/31

(52) U.S. Cl. CPC H04N 9/3147; H04N 9/3144; H04N 9/3155; H04N 9/3185

(57) ABSTRACT

A control method includes projecting a first image group having a first state in which brightness of a first projection image is greater than zero and brightness of a second projection image is zero on a projection surface in a corresponding region where parts of the first and second projection images overlap, acquiring first imaging data by imaging the corresponding region with the first image group projected on the projection surface, projecting a second image group having a second state in which brightness of the first projection image is zero and brightness of the second projection image is greater than zero in the corresponding region, acquiring second imaging data by imaging the corresponding region with the second image group projected on the projection surface, and detecting a position difference between the first and second projection images in an overlapping region range by analyzing the first and second imaging data.

The present application is based on, and claims priority from JP Application Serial Number 2023-207535, filed Dec. 8, 2023, the disclosure of which is hereby incorporated by reference herein in its entirety.

### BACKGROUND

### 1. Technical Field

The present disclosure relates to a control method, a projector, and a non-transitory computer-readable storage medium.

### 2. Related Art

For example, JP-A-2021-61510 discloses a projection including acquiring means for acquiring a captured image obtained by imaging of a region of a projection surface containing at least an overlapping region where a first projection image projected by a first projector on the projection surface and a second projection image projected by a second projector on the projection surface overlap each other, and detecting means for analyzing the captured image and detecting magnitude and a direction of a difference in position between the first projection image and the second projection image in the overlapping region. The detecting means detects the difference in position based on a frequency spectrum image obtained by application of two-dimensional Fourier transform processing to the captured image.

JP-A-2021-61510 is an example of the related art.

In the technique described in JP-A-2021-61510, there is a problem that it may be impossible to generate an accurate frequency spectrum in the above described two-dimensional Fourier transform processing depending on the type of the projection image, and as a result, detection accuracy of the detecting means may be lower.

### SUMMARY

A control method according to an aspect of the present disclosure is a control method in a multi-projection system in which an overlapping region is set, the overlapping region being a region in which a part of a first projection image projected from a first projector overlaps with a part of a second projection image projected from a second projector on a projection surface, and the control method includes projecting a first image group having a first state in which brightness of the first projection image is greater than zero and brightness of the second projection image is zero on the projection surface in a corresponding region corresponding to the overlapping region, acquiring first imaging data by imaging the corresponding region with the first image group projected on the projection surface, projecting a second image group having a second state in which the brightness of the first projection image is zero and the brightness of the second projection image is greater than zero on the projection surface in the corresponding region, acquiring second imaging data by imaging the corresponding region with the second image group projected on the projection surface, and detecting a difference in position between the first projection image and the second projection image in a range of the overlapping region by analyzing the first imaging data and the second imaging data.

A projector according to another aspect of the present disclosure is a projector used as a first projector in a multi-projection system in which an overlapping region is set, the overlapping region being a region in which a part of a first projection image projected from the first projector and a part of a second projection image projected from a second projector to overlap with each other on a projection surface, the projector includes an optical device, and a processing device, and the processing device executes controlling an operation of the optical device and controlling an operation of the second projector to project a first image group having a first state in which brightness of the first projection image is greater than zero and brightness of the second projection image is zero on the projection surface in a corresponding region corresponding to the overlapping region, acquiring first imaging data by an imaging device imaging the corresponding region with the first image group projected on the projection surface, controlling the operation of the optical device and controlling the operation of the second projector to project a second image group having a second state in which the brightness of the first projection image is zero and the brightness of the second projection image is greater than zero on the projection surface in the corresponding region, acquiring second imaging data by the imaging device imaging the corresponding region with the second image group projected on the projection surface, and detecting a difference in position between the first projection image and the second projection image in a range of the overlapping region by analyzing the first imaging data and the second imaging data.

A non-transitory computer-readable storage medium storing a program according to an aspect of the present disclosure is a non-transitory computer-readable storage medium storing a program used in a multi-projection system in which an overlapping region is set, the overlapping region being a region in which a part of a first projection image projected from a first projector and a part of a second projection image projected from a second projector to overlap with each other on a projection surface, and the program is used for controlling a computer to execute projecting a first image group having a first state in which brightness of the first projection image is greater than zero and brightness of the second projection image is zero on the projection surface in a corresponding region corresponding to the overlapping region, acquiring first imaging data by an imaging device imaging the corresponding region with the first image group projected on the projection surface, projecting a second image group having a second state in which the brightness of the first projection image is zero and the brightness of the second projection image is greater than zero on the projection surface in the corresponding region, acquiring second imaging data by the imaging device imaging the corresponding region with the second image group projected on the projection surface, and detecting a difference in position between the first projection image and the second projection image in a range of the overlapping region by analyzing the first imaging data and the second imaging data.

### BRIEF DESCRIPTION OF THE DRAWINGS

FIG. 1 shows an overview of a multi-projection system used for a control method according to a first embodiment.

FIG. 2 is a block diagram of a projector according to the first embodiment.

FIG. 3 is a flowchart showing a flow of the control method according to the first embodiment.

FIG. 4 shows initial alignment.

FIG. 5 shows a first image group.

FIG. 6 shows a second image group.

FIG. 7 shows an analysis region used for calculation of a correction amount and coordinate transformation of the analysis region.

FIG. 8 shows a matching processing between a first partial region and the analysis region.

FIG. 9 shows calculation of a difference in position between a first projection image and a second projection image in a range of an overlapping region.

FIG. 10 shows a blend range in a period for calculation of the correction amount.

FIG. 11 is a block diagram of a projector according to a second embodiment.

FIG. 12 is a flowchart illustrating a flow of a control method according to the second embodiment.

FIG. 13 shows a blend range in a period for calculation of a correction amount.

### DESCRIPTION OF EMBODIMENTS

As below, preferred embodiments according to the present disclosure will be described with reference to the accompanying drawings. In the drawings, the dimensions and scales of the respective parts are appropriately different from actual ones, and some parts are schematically shown to facilitate understanding. The scope of the present disclosure is not limited to the following embodiments unless otherwise specified in the following description.

### 1. First Embodiment

### 1-1. Overview of Multi-projection System

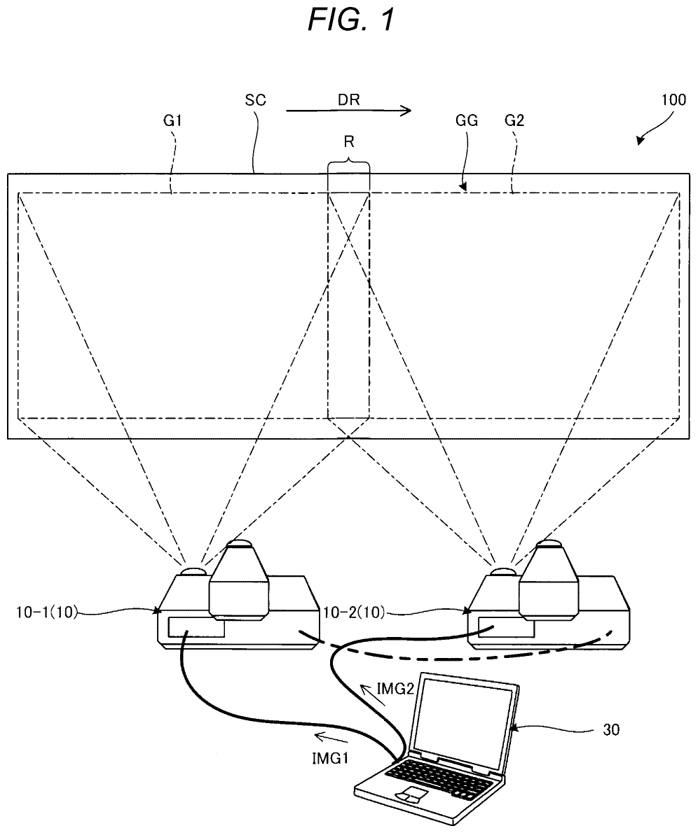

FIG. 1 shows an overview of a multi-projection system 100 used for a control method according to a first embodiment. As shown in FIG. 1, the multi-projection system 100 includes a first projector 10-1, a second projector 10-2, and a terminal device 30. The first projector 10-1 is an example of “projector”. Hereinafter, the first projector 10-1 and the second projector 10-2 may be referred to as projectors 10 without distinction from each other.

The multi-projection system 100 projects an image group GG on a projection surface SC using the plurality of projectors 10. In the example shown in FIG. 1, the multi-projection system 100 projects the image group GG containing a first projection image G1 and a second projection image G2 on the projection surface SC using the two projectors 10. The projection surface SC is a surface of an object such as a screen. In the example shown in FIG. 1, the projection surface SC is a flat surface.

The projection surface SC is not limited to the flat surface, but may be, for example, a curved surface. Further, in the embodiment, a configuration in which the number of the projectors 10 provided in the multi-projection system 100 is two is exemplified, however, the number may be three or more. That is, the image group GG may contain images projected from three or more projectors 10.

The first projector 10-1 is a display device that projects the first projection image G1 represented by image data IMG1 output from the terminal device 30 on the projection surface SC. On the other hand, the second projector 10-2 is a display device that projects the second projection image G2 represented by image data IMG2 output from the terminal device 30 on the projection surface SC.

The first projection image G1 and the second projection image G2 are arranged in an arrangement direction DR in this order. Here, the first projection image G1 and the second projection image G2 are projected to be joined to each other on the projection surface SC so that the image group GG displays a single image. In the example shown in FIG. 1, the first projection image G1 is projected on a left region of the projection surface SC in FIG. 1, and the second projection image G2 is projected on a right region of the projection surface SC in FIG. 1. Then, an end part on the right side of the first projection image G1 in FIG. 1 and an end part on the left side of the second projection image G2 in FIG. 1 are coupled to each other. That is, the end part on the right side of the first projection image G1 in FIG. 1 overlaps with the end part on the left side of the second projection image G2 in FIG. 1.

The first projection image G1 and the second projection image G2 partially overlap with each other in an overlapping region R. The overlapping region R is a region where blending processing, which will be described later, is performed to make the joint between the first projection image G1 and the second projection image G2 less noticeable. As described above, in the multi-projection system 100, the overlapping region R for a part of the first projection image G1 projected from the first projector 10-1 and a part of the second projection image G2 projected from the second projector 10-2 overlapping with each other on the projection surface SC is set.

In the embodiment, the first projector 10-1 is a main device and controls the operation of the second projector 10-2 as a sub-device. The first projector 10-1 has a correction function of correcting misalignment between the second projection image G2 and the first projection image G1. The second projector 10-2 has the same configuration as the first projector 10-1 except that the correction function is provided. The second projector 10-2 may have a configuration different from that of the first projector 10-1 as long as the operation thereof can be controlled by the first projector 10-1. When the number of projectors 10 of the multi-projection system 100 is three or more, among the three or more projectors 10, one projector 10 is a main device, and the other two or more projectors 10 are sub devices.

The terminal device 30 is a device having a function of dividing image data representing a single image into a plurality of pieces of image data to be projected by the plurality of projectors 10, and a function of supplying each piece of image data by the division process to the corresponding projector 10.

The terminal apparatus 30 of the embodiment divides the image data representing a single image into the image data IMG1 and the image data IMG2, and then, supplies the image data IMG1 to the first projector 10-1 and supplies the image data IMG2 to the second projector 10-2.

In the example shown in FIG. 1, the terminal device 30 is a notebook computer. Note that the terminal device 30 is not limited to the notebook computer, and may be, for example, a desktop computer, a smartphone, a tablet terminal, or the like, or may be a video reproducer, a DVD (Digital Versatile Disk) player, a Blu-ray disk player, a hard disk recorder, a television tuner, a set-top box for a CATV (Cable television), a video game machine, or the like.

### 1-2. Projector

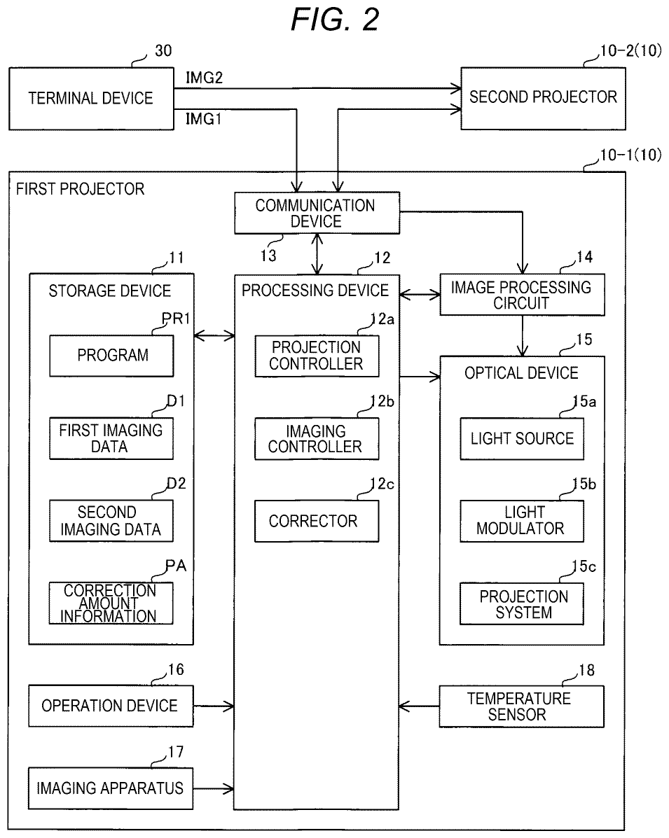

FIG. 2 is a block diagram of the first projector 10-1 according to the first embodiment. FIG. 2 shows the first projector 10-1 and a coupling condition of the second projector 10-2 and the terminal apparatus 30 to the first projector 10-1. In FIG. 2, the configuration of the first projector 10-1 is representatively shown, however, the configuration of the second projector 10-2 is the same as the configuration of the first projector 10-1 except that the correction function is not provided, and the image data IMG1 may be read as the image data IMG2 in the following description of the component elements. Hereinafter, regarding the component elements of the projector 10, the component elements of the first projector 10-1 and the component elements of the second projector 10-2 may be distinguished from each other by addition of suffixes “-1” to the reference signs of the component elements of the first projector 10-1 and addition of suffixes “-2” to the reference signs of the component elements of the second projector 10-2.

As shown in FIG. 2, the first projector 10-1 includes a storage device 11, a processing device 12, a communication device 13, an image processing circuit 14, an optical device 15, an operation device 16, an imaging device 17, and a temperature sensor 18. These devices are communicably coupled to one another.

The storage device 11 is a storage device that stores programs executed by the processing device 12 and data processed by the processing device 12. The storage device 11 includes, for example, a hard disk drive or a semiconductor memory. A part or all of the storage device 11 may be provided in a storage device, a server, or the like outside the first projector 10-1.

The storage device 11 stores a program PR1, first imaging data D1, second imaging data D2, and correction amount information PA.

The program PR1 is a program for execution of a control method, which will be described in detail later. The first imaging data D1 is data representing an image acquired by the imaging device 17 imaging a corresponding region RC, which will be described later, corresponding to the overlapping region R when the first projection image G1 is projected on the projection surface SC as will be described later. The second imaging data D2 is data representing an image acquired by the imaging device 17 imaging the corresponding region RC to be described later when the second projection image G2 is projected on the projection surface SC as will be described later. The correction amount information PA is information representing a correction amount for correction of a difference in position between the first projection image G1 and the second projection image G2 in the range of the overlapping region R.

The processing device 12 is a processing device having a function of controlling the respective units of the first projector 10-1 and a function of processing various kinds of data. The processing device 12 includes, for example, a processor such as a CPU (Central Processing Unit). Note that the processing device 12 may include a single processor or may include a plurality of processors. Part or all of the functions of the processing device 12 may be implemented by hardware such as a DSP (Digital Signal Processor), an ASIC (Application Specific Integrated Circuit), a PLD (Programmable Logic Device), or an FPGA (Field Programmable Gate Array). The processing device 12 may be integrated with the image processing circuit 14.

The communication device 13 is a communication device that can communicate with various devices, and acquires the image data IMG1 from the terminal device 30 and communicates with the second projector 10-2. For example, the communication device 13 is a wired communication device such as a wired LAN (Local Area Network), a USB (Universal Serial Bus), or an HDMI (High Definition Multimedia Interface), or a wireless communication device such as an LPWA (Low Power Wide Area), a wireless LAN including Wi-Fi, or Bluetooth. Each of “HDMI”, “Wi-Fi”, and “Bluetooth” is a registered trademark.

The image processing circuit 14 is a circuit that performs necessary processing on the image data IMG1 from the communication device 13 and inputs the data to the optical device 15. The image processing circuit 14 has, for example, a frame memory (not shown), loads the image data IMG1 into the frame memory, appropriately executes various kinds of processing such as resolution conversion processing, resizing processing, and distortion correction processing, and inputs the data to the optical device 15. Further, the image processing circuit 14 executes processing of correcting the difference in position between the first projection image G1 and the second projection image G2 at least in the range of the overlapping region R based on the correction amount information PA stored in the storage device 11. Note that the image processing circuit 14 may execute processing such as OSD (On Screen Display) processing of generating image information for menu display, an operation guide, or the like and synthesizing the information with the image data IMG1 as necessary. Alternatively, the image processing circuit 14 may execute processing of correcting a difference in position between the entire of first projection image G1 and the entire of second projection image G2 based on the correction amount information PA stored in the storage device 11.

The optical device 15 is a device that projects an image light on the projection surface SC. The optical device 15 includes a light source 15a, a light modulator 15b, and a projection system 15c. The projection system 15c of the first projector 10-1 is an example of “first optical system”. Although not illustrated, the second projector 10-2 includes the projection system 15c like the first projector 10-1, and the projection system 15c of the second projector 10-2 is an example of “second optical system”.

The light source 15a includes a light source such as a halogen lamp, a xenon lamp, an ultra-high pressure mercury lamp, an LED (light emitting diode), or a laser light source, and respectively emits red, green, and blue lights. The light modulator 15b draws an image based on the image data IMG1 supplied from the terminal device 30. The light modulator 15b of the first projector 10-1 is an example of a drawing panel of the first projector. The light modulator 15b of the first projector 10-1 may be referred to as a first drawing panel, and the light modulator 15b of the second projector 10-2 may be referred to as a second drawing panel. The light modulator 15b includes three optical modulation elements provided to correspond to red, green, and blue. Each light modulation element includes, for example, a transmissive liquid crystal panel, a reflective liquid crystal panel, or a DMD (digital mirror device), and modulates the light of the corresponding color to generate an image light of each color. The image lights of the respective colors generated by the light modulator 15b are synthesized by a light combining system into a full-color image light. The projection system 15c is an optical system including a projection lens that forms an image of the full-color image light from the light modulator 15b and projects the image on the projection surface SC. The image drawn by the light modulator 15b, that is, a drawn image is projected on the projection surface SC via the projection lens.

The operation device 16 is a device that receives an operation from a user. For example, the operation device 16 includes an operation panel and a remote control light receiver (not shown). The operation panel is provided on an exterior housing of the first projector 10-1 and outputs a signal based on an operation by the user. The remote control light receiver receives an infrared signal from a remote controller (not shown), decodes the infrared signal, and outputs a signal based on the operation of the remote controller. The operation device 16 is provided as necessary, or may be omitted.

The imaging device 17 is a digital camera having an imaging device such as a CCD (charge coupled device) or a CMOS (Complementary Metal Oxide Semiconductor). The imaging device includes a plurality of pixels.

The temperature sensor 18 is a temperature sensor such as a thermistor that detects the temperature of the projection system 15c. The temperature sensor 18 is provided in the projector 10 and fixed to a predetermined location near the projection system 15c within the housing of the projector 10. When the temperature sensors 18 of both the first projector 10-1 and the second projector 10-2 are used, the temperatures of the projection systems 15c of both the first projector 10-1 and the second projector 10-2 can be detected.

In the above described first projector 10-1, the processing device 12 functions as a projection controller 12a, an imaging controller 12b, and a corrector 12c by executing the program PR1 stored in the storage device 11. The processing device 12 includes the projection controller 12a, the imaging controller 12b, and the corrector 12c.

The projection controller 12a controls operations of the image processing circuit 14 and the optical device 15 of each of the first projector 10-1 and the second projector 10-2. More specifically, the projection controller 12a projects a first image group GG1, which will be described later, on the projection surface SC, and projects a second image group GG2, which will be described later, on the projection surface SC.

The imaging controller 12b controls the operation of one or both of the imaging devices 17 of the first projector 10-1 and the second projector 10-2. More specifically, the imaging controller 12b acquires the first imaging data D1 and the second imaging data D2 by the imaging device 17 imaging the corresponding region RC to be described later when the first image group GG1 to be described later is projected on the projection surface SC and by the imaging device 17 imaging the corresponding region RC to be described later when the second image group GG2 to be described later is projected on the projection surface SC.

The corrector 12c generates the correction amount information PA based on the first imaging data D1 and the second imaging data D2. More specifically, the corrector 12c analyzes the first imaging data D1 and the second imaging data D2 to detect the difference in position between the first projection image G1 and the second projection image G2 in the range of the overlapping region R, and generates the correction amount information PA based on the detection result.

### 1-3. Control Method

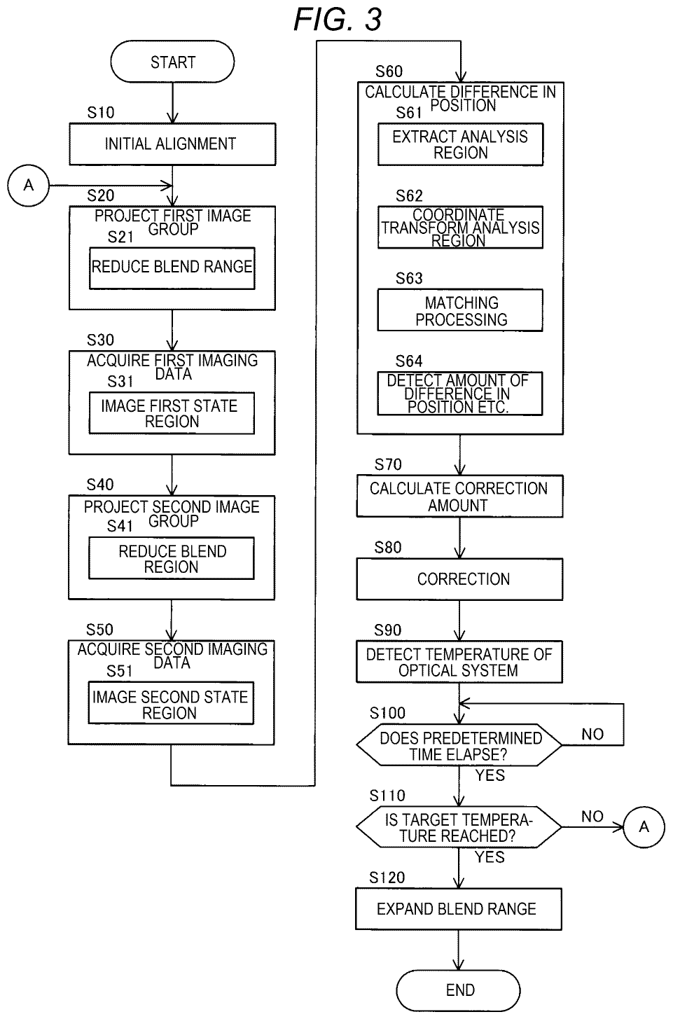

FIG. 3 is a flowchart showing a flow of the control method according to the first embodiment. The control method is performed using the above described multi-projection system 100.

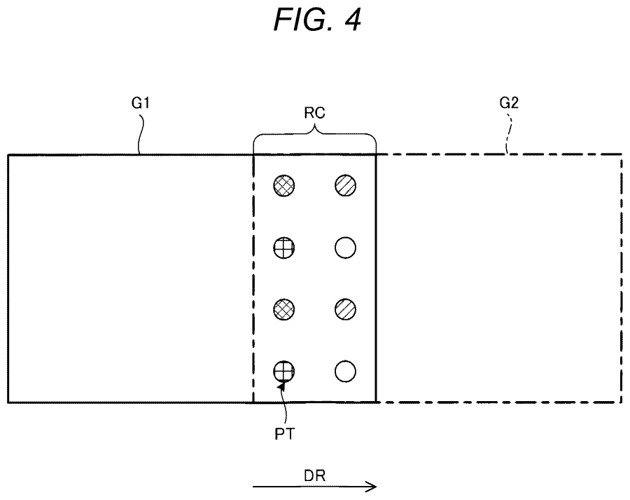

In the control method of the embodiment, first, as shown in FIG. 3, at step S10, the processing device 12 performs initial alignment between the coordinate system of the imaging device 17 and the coordinate system of the optical device 15. As will be described later in detail with reference to FIG. 4, the initial alignment is performed by correlating the coordinate system of the imaging device 17 of the first projector 10-1 with the coordinate system of the optical device 15 of each of the first projector 10-1 and the second projector 10-2.

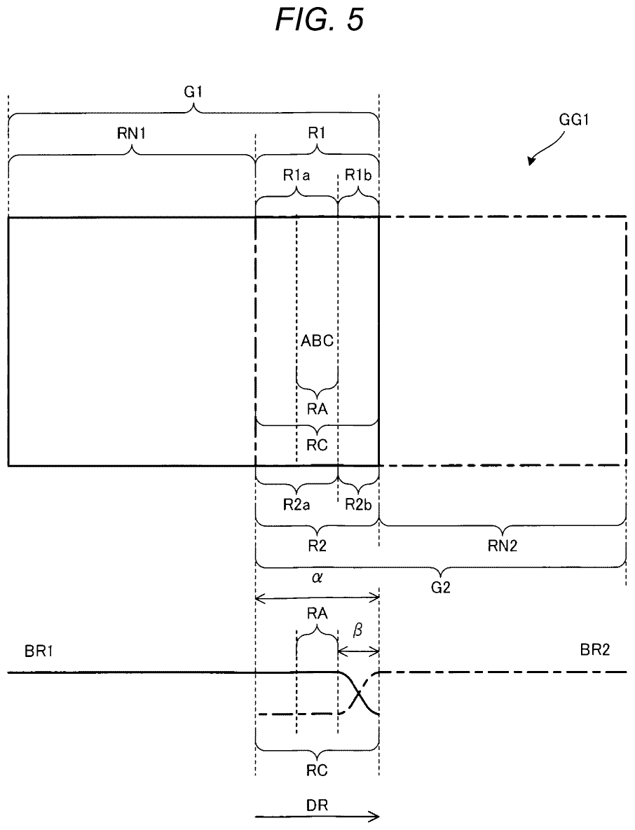

After step S10, at step S20, the projection controller 12a projects the first image group GG1 to be described later on the projection surface SC. As will be described later in detail with reference to FIG. 5, the first image group GG1 is an image group GG having a first state in which brightness BR1 of the first projection image G1 is greater than zero and brightness BR2 of the second projection image G2 is zero in at least a part of the corresponding region RC corresponding to the overlapping region R. Step S20 of the embodiment includes step S21 of reducing a blend range as a range in which blend processing of the first projection image G1 and the second projection image G2 is performed. Note that, step S21 might not be included in step S20.

After step S20, at step S30, the imaging controller 12b acquires the first imaging data D1. As will be described later in detail with reference to FIG. 5, this acquisition is performed by the imaging device 17 imaging the corresponding region RC when the first image group GG1 is projected on the projection surface SC. Step S30 of the embodiment includes step S31 of imaging a first state region R1a, which will be described later.

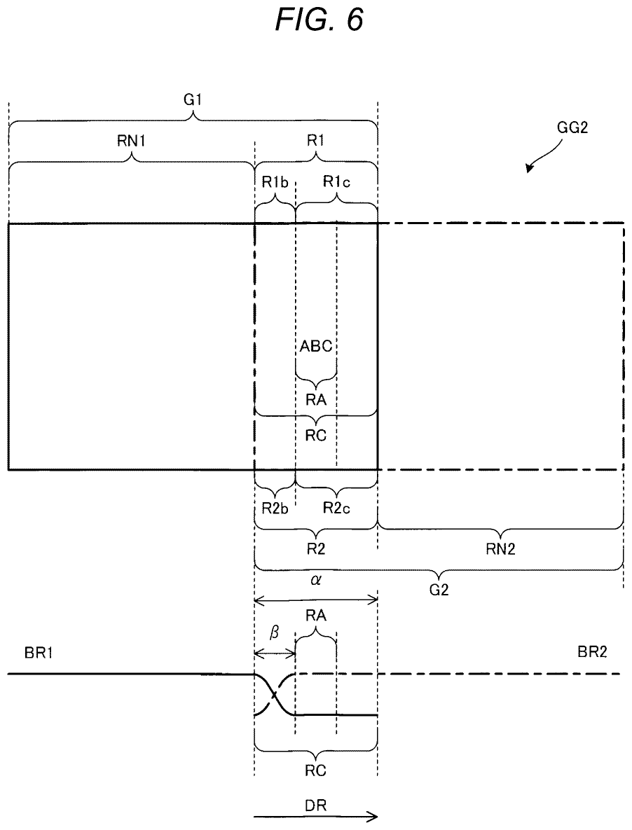

After step S30, at step S40, the projection controller 12a projects a second image group GG2, which will be described later, on the projection surface SC. As will be described later in detail with reference to FIG. 6, the second image group GG2 is an image group GG having a second state in which the brightness BR1 of the first projection image G1 is zero and the brightness BR2 of the second projection image G2 is greater than zero in at least a part of the corresponding region RC. Step S40 of the embodiment includes step S41 of reducing a blend range as a range in which blend processing of the first projection image G1 and the second projection image G2 is performed. Note that, step S41 might not be included in step S40.

After step S40, at step S50, the imaging controller 12b acquires the second imaging data D2. As will be described later in detail with reference to FIG. 6, this acquisition is performed by the imaging device 17 imaging the corresponding region RC when the second image group GG2 is projected on the projection surface SC. Step S50 of the embodiment includes step S51 of imaging a second state region R2c, which will be described later.

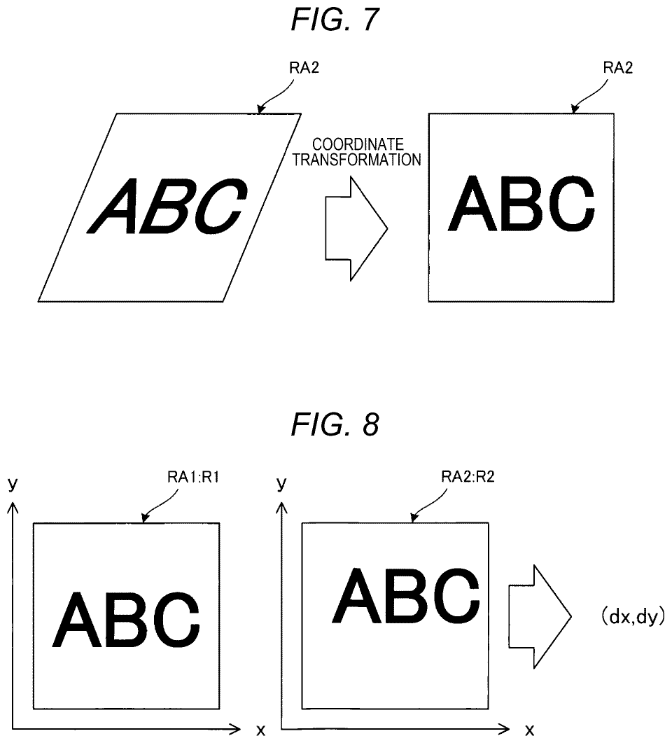

After step S50, at step S60, the corrector 12c detects a difference in position between the first projection image G1 and the second projection image G2 in the range of the overlapping region R. The details will be described later with reference to FIGS. 7 and 8, and this detection is performed by analyzing the first imaging data D1 and the second imaging data D2. Step S60 of the embodiment includes step S61 of extracting an analysis region RA1, which will be described later, step S62 of performing coordinate transformation of the analysis region RA1 to be described later, step S63 of performing matching processing, and step S64 of detecting an amount of difference in position or the like in this order.

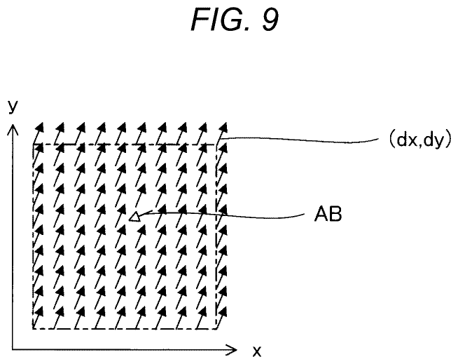

After step S60, at step S70, the corrector 12c calculates a correction amount based on the amount of difference or the like detected at step S60. The details of the calculation will be described later with reference to FIG. 9.

After step S70, at step S80, the corrector 12c generates correction amount information PA based on the correction amount calculated at step S70. The generated correction amount information PA is stored in the storage device 11. Thereby, the difference in position between the first projection image G1 and the second projection image G2 in the range of the overlapping region R is corrected.

After step S80, at step S90, the corrector 12c detects the temperature of the projection system 15c-1 based on the output from the temperature sensor 18.

In this manner, at step S90, the temperature of the projection system 15c-1 for the first projector 10-1 to project the first projection image G1 is detected based on the output from the temperature sensor 18.

After step S90, at step S100, the corrector 12c determines whether a predetermined time elapses, and repeats step S100 until the predetermined time elapses (step S100: NO).

When a determination that the predetermined time elapses is made (step S100: YES), at step S110, the corrector 12c determines whether the temperature reaches the target temperature based on the temperature detected at step S90.

When a determination that the target temperature is not reached is made (step S110: NO), the above described step S20 is executed. Thereby, the above described steps S20 to S110 are repeatedly executed until a determination that the target temperature is reached is made. Here, of the above described steps S20 to S110, the steps except step S100 are executed at predetermined time intervals by step S100. Thereby, the correction amount information PA is updated at predetermined time intervals so that the difference in position between the first projection image G1 and the second projection image G2 due to a change in optical characteristics of the projection system 15c or the like is corrected until the optical characteristics of the projection system 15c are stabilized.

In this manner, for “NO” at step S110, the detection of the difference in position and the correction of the difference in position are intermittently executed until the temperature of the projection system 15c-1 reaches the target temperature based on the output from one or more temperature sensors 18.

When a determination that the target temperature is reached is made (step S110: YES), at step S120, the projection controller 12a expands the blend range as the range in which the blend processing of the first projection image G1 and the second projection image G2 is performed to the entire of the overlapping region R. After step S120, the processing for detecting the difference in position and correcting the difference in position ends. Note that step S120 may be executed as necessary or may be omitted. In this case, when a determination that the target temperature is reached (step S110: NO), the processing for detecting the difference in position and correcting the difference in position ends with the blend range maintained as a second range β.

As described above, when “YES” at step S110, after the temperature of the projection system 15c-1 reaches the target temperature based on the output from one or more temperature sensors 18, the processing device 12 stops the detection of the difference in position and the correction of the difference in position. This is because the difference in position between the first projection image G1 and the second projection image G2 is mainly caused by a change in optical characteristics due to a temperature change of the projection system 15c. The change in optical characteristics occurs due to, for example, a change in amount of distortion of the projection system 15c.

In the above described manner, the control method for the multi-projection system 100 is executed. As below, steps S10 to S80 will be sequentially described in detail.

FIG. 4 shows the initial alignment. At step S10, as shown in FIG. 4, first, with the image group GG0 projected on the projection surface SC, the imaging device 17 of the first projector 10-1 images the corresponding region RC. The corresponding region RC is a region corresponding to the overlapping region R on the projection surface SC. Specifically, the corresponding region RC is a region having the same number of pixels or the same width as the overlapping region R in the arrangement direction DR. The width is indicated by, for example, the metric system or the yard-pound system. In the corresponding region RC, as will be described later, the brightness of one of the first projection image G1 and the second projection image G2 may be greater than zero and the brightness of the other may be zero. For example, when the brightness of the first projection image G1 is greater than zero in the entire corresponding region RC and the brightness of the second projection image G2 is zero in the entire corresponding region RC, that is, the second projection image G2 is a black image, substantially only the first projection image G1 is projected on the projection surface SC in the corresponding region RC. Accordingly, the first projection image G1 does not include a region overlapping with the second projection image G2, that is, the overlapping region R. On the other hand, in normal use in which the user projects a desired content as the image group GG on the projection surface SC, the image group GG in which both the brightness of the first projection image G1 and the brightness of the second projection image G2 are greater than zero may be projected in the corresponding region RC, and thus, the first projection image G1 has the overlapping region R overlapping with the second projection image G2. Accordingly, the corresponding region RC is a region that may be the overlapping region R in normal use. The image group GG0 is an image group GG in which each of the first projection image G1 and the second projection image G2 includes a color code pattern PT.

Prior to step S10, the user adjusts the width of the overlap between the first projection image G1 and the second projection image G2. For example, the user adjusts the position of the second projector 10-2 relative to the position of the first projector 10-1 so that a part of the first projection image G1 overlaps with a part of the second projection image G2. Then, the user inputs information representing the width of the overlapping region R, for example, the number of pixels to the terminal device 30, and sets the width of the overlapping region R in the first projector 10-1 and the second projector 10-2. Thereby, the control method for the multi-projection system 100 is executed with the number of pixels of the overlapping region R set in the first projector 10-1 and the second projector 10-2. In the control method to be described later, the size of the blend region is variously changed, and the information representing the number of pixels of the overlapping region R is also used for the control.

The color code pattern PT in the first projection image G1 and the color code pattern PT in the second projection image G2 are identifiably displayed in the image group GG0. The position of the color code pattern PT in the first projection image G1 is known as coordinate values in the coordinate system of the optical device 15 of the first projector 10-1. On the other hand, the position of the color code pattern PT in the second projection image G2 is known as coordinate values in the coordinate system of the optical device 15 of the second projector 10-2. In the coordinate system of the optical device 15 of the first projector 10-1, each pixel of the light modulation element of the optical device 15 of the first projector 10-1 is indicated by coordinate values. In the coordinate system of the optical device 15 of the second projector 10-2, each pixel of the light modulation element of the optical device 15 of the second projector 10-2 is indicated by coordinate values.

At step S10, the coordinate system of the imaging device 17 of the first projector 10-1 is correlated with the coordinate system of the optical device 15 of each of the first projector 10-1 and the second projector 10-2 based on the captured image obtained by the imaging device 17 of the first projector 10-1 capturing the image group GG0. Here, the coordinate system of the imaging device 17 of the first projector 10-1 is a two-dimensional coordinate system of the captured image acquired by the imaging device 17, and the coordinate system of the optical device 15 of each of the first projector 10-1 and the second projector 10-2 is a two-dimensional coordinate system of the drawing panel of each of the first projector 10-1 and the second projector 10-2. In the coordinate system of the imaging device 17 of the first projector 10-1, each pixel of the imaging element of the imaging device 17 of the first projector 10-1 is indicated by coordinate values.

Here, since the color code pattern PT in the first projection image G1 and the color code pattern PT in the second projection image G2 are identifiably displayed in the image group GG as described above, the position of the color code pattern PT in the first projection image G1 and the position of the color code pattern PT in the second projection image G2 can be respectively detected as coordinate values in the coordinate system of the imaging device 17 of the first projector 10-1 based on the captured image.

Further, since the position of the color code pattern PT in the first projection image G1 is known as the coordinate values in the coordinate system of the optical device 15 of the first projector 10-1 as described above, the coordinate system of the imaging device 17 of the first projector 10-1 can be correlated with the coordinate system of the optical device 15 of the first projector 10-1. Similarly, since the position of the color code pattern PT in the second projection image G2 is known as the coordinate values in the coordinate system of the optical device 15 of the second projector 10-2 as described above, the coordinate system of the imaging device 17 of the first projector 10-1 can be correlated with the coordinate system of the optical device 15 of the second projector 10-2.

Note that FIG. 4 exemplifies the configuration using the color code pattern PT for the image group GG0, however, in place of the color code pattern PT, various patterns with which the coordinate system of the imaging device 17 of the first projector 10-1 can be correlated with the coordinate system of the optical device 15 of each of the first projector 10-1 and the second projector 10-2 may be used.

FIG. 5 shows the first image group GG1. At step S20, as shown in FIG. 5, the first image group GG1 is projected on the projection surface SC. The first image group GG1 is an image group GG having a first state in which the brightness BR1 of the first projection image G1 is greater than zero and the brightness BR2 of the second projection image G2 is zero in the corresponding region RC. Note that “brightness is zero” refers to a luminance value of a black image. In FIG. 5, for convenience of description, the characters “ABC” are displayed in the corresponding region RC of the first image group GG1.

The first projection image G1 has a non-overlapping region RN1 and a first partial region R1. The non-overlapping region RN1 is a region not overlapping with the second projection image G2. The first partial region R1 is a region to overlap with the second projection image G2. At least a part of the first partial region R1 is a first blend region R1b as a region to be subjected to the blend processing. The blend processing changes the brightness in the arrangement direction DR in which the first projection image G1 and the second projection image G2 are arranged such that the brightness of the overlapping region R when the first projection image G1 and the second projection image G2 are projected to overlap with each other in the overlapping region R may be equal to the brightness of the non-overlapping region RN1.

On the other hand, the second projection image G2 has a non-overlapping region RN2 and a second partial region R2. The non-overlapping region RN2 is a region not overlapping with the first projection image G1. The second partial region R2 is a region to overlap with the first projection image G1. At least a part of the second partial region R2 is a second blend region R2b as a region to be subjected to the blend processing.

At step S21 of step S20, the processing device 12 controls the first drawing panel to change the blend range on which the blend processing is performed in the first partial region R1 from a first range α to a second range β smaller than the first range α. Thereby, at step S21, the first partial region R1 is adjusted to include the first state region R1a having the first state in addition to the first blend region R1b. The first state region R1a includes a region corresponding to the analysis region RA. That is, the analysis region RA is a partial region of the first partial region R1, in which the characters “ABC” are displayed in the corresponding region RC on the projection surface SC. In the first state region R1a, the brightness BR1 of the first projection image G1 is greater than zero. In the example shown in FIG. 5, the first state region R1a is disposed in a position in a direction opposite to the arrangement direction DR with respect to the position of the first blend region R1b. In other words, at step S21 of step S20, the processing device 12 moves, that is, shifts the first blend region R1b to a position on one side (right side) with respect to the first state region R1a in the arrangement direction DR.

Similarly, at step S21 of step S20, the processing device 12 controls the second drawing panel to change the blend range in which the blend processing is performed on the second partial region R2 from the first range α to the second range β. Thereby, at step S21, the second partial region R2 is adjusted to include the first state region R2a having the first state in addition to the second blend region R2b. The first state region R2a includes a region corresponding to the analysis region RA of the first partial region R1. In the first state region R2a, the brightness BR2 of the second projection image G2 is zero. Accordingly, in the first state region R1a or the first state region R2a, it is observed that only the first projection image G1 is projected as seen from the user or the imaging device 17. The brightness BR2 of the analysis region RA of the first state region R2a is zero. In the example shown in FIG. 5, the first state region R2a is disposed in a position in a direction opposite to the arrangement direction DR with respect to the position of the second blend region R2b. In other words, at step S21 of step S20, the processing device 12 moves, that is, shifts the second blend region R2b to a position on the one side (right side) with respect to the first state region R2a in the arrangement direction DR.

The first range α is, for example, a blend range applied at step S120. In the example shown in FIG. 5, the first range α is the entire first partial region R1. The first range α is not limited to the example shown in FIG. 5, but may be smaller than the first partial region R1 or the second partial region R2 as long as the first range is larger than the second range β.

As described above, at step S21, the blend range as the range in which the blend processing of the first projection image G1 and the second projection image G2 is performed is reduced in the arrangement direction DR.

In the first blend region R1b, the brightness BR1 of the first projection image G1 changes from the brightness of the non-overlapping region RN1 to zero over the second range β in the alignment direction DR. In contrast, although not illustrated, when the blend range of the first blend region R1b is the first range α, the brightness BR1 of the first projection image G1 changes from the brightness of the non-overlapping region RN1 to zero over the first range a larger than the second range β in the arrangement direction DR. Accordingly, in the first blend region R1b, a distribution of brightness in the arrangement direction DR when the blend range is the second range β is different from a distribution of brightness in the arrangement direction DR when the blend range is the first range α. In the first blend region R1b, the distribution of the brightness BR1 in the arrangement direction DR, that is, a blend curve is not limited to the example shown in FIG. 5 as long as the brightness of the overlapping region R is set to be equal to the brightness of the non-overlapping region RN1.

On the other hand, in the second blend region R2b, the brightness BR2 of the second projection image G2 changes from the brightness of the non-overlapping region RN2 to zero over the second range β in the direction opposite to the arrangement direction DR. In contrast, although not illustrated, when the blend range of the second blend region R2b is the first range α, the brightness BR2 of the second projection image G2 changes from the brightness of the non-overlapping region RN2 to zero over the first range a larger than the second range β in the direction opposite to the arrangement direction DR. Accordingly, in the second blend region R2b, a distribution of brightness in the arrangement direction DR when the blend range is the second range β is different from a distribution of brightness in the arrangement direction DR when the blend range is the first range α. In the second blend region R2b, the distribution of the brightness BR2 in the arrangement direction DR, that is, the blend curve is not limited to the example shown in FIG. 5 as long as the brightness of the overlapping region R is equal to the brightness of the non-overlapping region RN2.

At step S31 of step S30, the imaging device 17 images the corresponding region RC, that is, the first state region R1a or the first state region R2a. As described above, at step S30, the first imaging data DI is acquired by the imaging device 17 imaging the corresponding region RC with the first image group GG1 projected on the projection surface SC. The first imaging data D1 includes at least an image of the analysis region RA as a part of the first partial region R1.

As described above, since the brightness of the first projection image G1 is greater than zero and the brightness of the second projection image G2 is zero in the first state region R1a or the first state region R2a, the imaging device 17 can acquire the first imaging data D1 not affected by the brightness of the second projection image G2. At step S31 of step S30, the state in which the blend range is the second range β is maintained in at least a part of a period in which the imaging device 17 images the first state region R1a or the first state region R2a. At step S30, the region imaged by the imaging device 17 may include a region corresponding to the analysis region RA1, which will be described later.

FIG. 6 shows the second image group GG2. At step S40, as shown in FIG. 6, the second image group GG2 is projected on the projection surface SC. The second image group GG2 is an image group GG having a second state in which the brightness BR1 of the first projection image G1 is zero and the brightness BR2 of the second projection image G2 is greater than zero in the corresponding region RC. In FIG. 6, for convenience of description, the characters “ABC” are displayed in the corresponding region RC of the second image group GG2 like the above described first image group GG1 in FIG. 5.

At step S40, the first partial region R1 of the first projection image G1 is adjusted to include a second state region R1c having the second state in addition to the first blend region R1b. The second state region R1c includes a region corresponding to the analysis region RA. In the second state region R1c, the brightness BR1 of the first projection image G1 is zero. Further, at step S40, the range of the first blend region R1b is the second range β like that at the above described step S20. In the example shown in FIG. 6, the second state region R1c is disposed in a position in the arrangement direction DR with respect to the first blend region R1b. In other words, at step S41 of step S40, the processing device 12 moves, that is, shifts the first blend region R1b to a position on the other side (left side) with respect to the second state region R1c in the arrangement direction DR.

Similarly, at step S40, the second partial region R2 of the second projection image G2 is adjusted to include the second state region R2c having the second state in addition to the second blend region R2b. The second state region R2c includes a region corresponding to the analysis region RA of the second partial region R2. That is, the analysis region RA is a partial region of the second partial region R2, in which the characters “ABC” are displayed in the corresponding region RC on the projection surface SC. In the second state region R2c, the brightness BR2 of the second projection image G2 is greater than zero. As described above, in the second state region R1c, the brightness BR1 of the first projection image G1 is zero. Accordingly, in the second state region R1c or the second state region R2c, it is observed that only the second projection image G2 is projected as seen from the user or the imaging device 17. Furthermore, at step S40, the range of the second blend region R2b is the second range β like that at the above described step S20. In the example shown in FIG. 6, the second state region R2c is disposed in a position in the arrangement direction DR with respect to the position of the second blend region R2b. In other words, at step S41 of step S40, the processing device 12 moves, that is, shifts the second blend region R2b to a position on the other side (left side) with respect to the second state region R2c in the arrangement direction DR.

At step S50, the imaging device 17 images the second state region R1c or the second state region R2c. As described above, at step S50, the second imaging data D2 is acquired by the imaging device 17 imaging the corresponding region RC with the second image group GG2 projected on the projection surface SC. The second imaging data D2 includes at least an image of the analysis region RA as a part of the second partial region R2.

As described above, since the brightness of the first projection image G1 is zero and the brightness of the second projection image G2 is greater than zero in the second state region R1c or the second state region R2c, the imaging device 17 can acquire the second imaging data D2 not affected by the brightness of the first projection image G1. At step S51 of step S50, the state in which the blend range is the second range β is maintained in at least a part of a period in which the imaging device 17 images the second state region R1c or the second state region R2c. Note that, at step S50, the region imaged by the imaging device 17 may include a region corresponding to the analysis region RA1 to be described later.

FIG. 7 shows the analysis region RA2 used for calculation of a correction amount and coordinate transformation of the analysis region RA2. At step S60, first, at step S61, the analysis region RA2 as a part of the second imaging data D2 is extracted from the second imaging data D2 as shown on the left side in FIG. 7. The analysis region RA2 is a region corresponding to the above described analysis region RA of the image represented by the second imaging data D2. Here, the image represented by the second imaging data D2 is expressed in the coordinate system of the imaging device 17, and the analysis region RA2 is expressed in the coordinate system of the imaging device 17.

After step S61, at step S62, as shown on the right side in FIG. 7, the analysis region RA2 is transformed into a region in the coordinate system of the first projector 10-1. Specifically, the analysis region RA2 is transformed into a region in the coordinate system of the light modulator 15b of the first projector 10-1. This transformation is performed based on the correlation obtained at the above described step S10. The analysis region RA2 transformed into the region in the coordinate system of the first projector 10-1 is an example of transformed data.

FIG. 8 shows matching processing between the first partial region R1 and the analysis region RA2. At step S63, matching processing such as phase-only correlation is performed on the first partial region R1 and the analysis region RA2. FIG. 8 exemplifies a configuration in which the analysis region RA1 corresponding to the above described analysis region RA of the first partial region R1 is used for the matching. The analysis region RA1 is expressed in the coordinate system of the first projector 10-1, that is, the coordinate system of the first drawing panel. The analysis region RA1 is a region corresponding to the analysis region RA of the first partial region R1 in the first projection image G1. The analysis region RA1 is an example of drawing data. That is, the analysis region RA1 is data input to the first drawing panel for the first projector 10-1 to draw the first partial region R1 including the analysis region RA on the first drawing panel. The analysis region RA1 is an example of the drawing data, and may include at least data corresponding to the analysis region RA of the first partial region R1.

Thus, each of the analysis region RA1 and the analysis region RA2 is expressed by coordinate values (x, y) in the coordinate system of the first projector 10-1. That is, in the embodiment, the matching processing for calculating the difference in position between the first projection image G1 and the second projection image G2 is performed as calculation exclusively in the coordinate system of the light modulator 15b (first drawing panel) of the first projector 10-1.

The analysis region RA1 may be obtained by extraction from the first imaging data D1 and transformation into a region in the coordinate system of the first projector 10-1.

As described above, since the brightness BR1 of the first projection image G1 is greater than zero and the brightness BR2 of the second projection image G2 is zero in the first partial region R1 of the first imaging data D1, and the position of the first projection image G1 can be detected without the influence of the second projection image G2 using the analysis region RA1. On the other hand, as described above, since the brightness BR1 of the first projection image G1 is zero and the brightness BR2 of the second projection image G2 is greater than zero in the second partial region R2 of the second imaging data D2, and the position of the second projection image G2 can be detected without the influence of the first projection image G1 using the analysis region RA2.

At step S64, one or both of the amount and direction of the difference in position between the first projection image G1 and the second projection image G2 are detected based on a result of the matching process. In the example shown in FIG. 8, detection values (dx, dy) indicating the amount and direction of difference in position between the first projection image G1 and the second projection image G2 are obtained. The detection values (dx, dy) are obtained with respect to a plurality of locations in the analysis regions RA1 and RA2.

FIG. 9 shows calculation of the difference in position between the first projection image G1 and the second projection image G2 in the range of the overlapping region R. At step S70, the first projector 10-1 calculates a correction amount for correction of the first projection image G1 based on the difference in position detected at step S60. More specifically, at step S70, an abnormal value AB is excluded from the detected values (dx, dy) of the difference in position in the plurality of locations calculated at step S60, and a value obtained from a relationship with other detected values around the abnormal value AB is complemented. Thereby, a more accurate correction amount is obtained. Information representing the correction amount is stored in the storage device 11 as correction amount information PA.

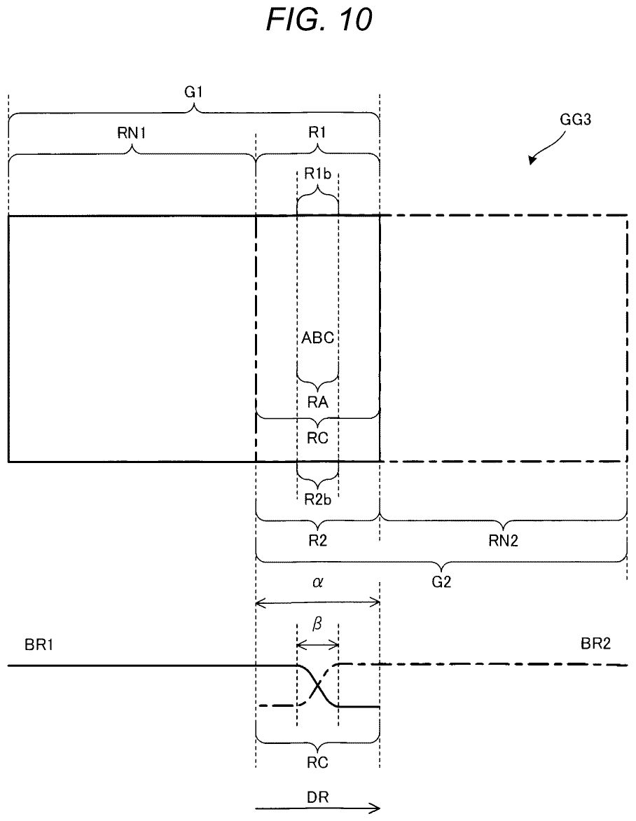

At step S70 of the embodiment, the blend range may be maintained in the second range β. The blend range during the execution of step S70 may be located on the left side of the corresponding region RC as shown in FIG. 5, may be located on the right side of the corresponding region RC as shown in FIG. 6, or may be located at the center of the corresponding region RC as shown in FIG. 10 described later. The blend range may move within the corresponding region RC. In this case, the movement of the blend range is preferably synchronized with a vertical synchronizing signal of the image data IMG1. The blend range during execution of step S70 may be smaller than the second range β.

FIG. 10 shows the blend range in a period for calculation of the correction amount. At step S80, the first projector 10-1 is controlled based on the correction amount calculated at step S70. Thereby, at step S80, as shown in FIG. 10, an image group GG3 is projected on the projection surface SC. The image group GG3 is an image group GG in which the difference in position between the first projection image G1 and the second projection image G2 is corrected based on the correction amount information PA. This correction is performed by adjusting the position of the first projection image G1 relative to the position of the second projection image G2. For example, at least one of the shape, position, and orientation of the drawn image drawn by the light modulator 15b of the first projector 10-1 is corrected so that the position of the first projection image G1 coincides with the position of the second projection image G2.

In the example shown in FIG. 10, the first blend region R1b and the second blend region R2b are disposed at the center of the corresponding region RC. The blend range of the first blend region R1b and the second blend region R2b is the second range β. Note that the blend range at step $80 is not limited to the example shown in FIG. 10, but may be located on the left side of the corresponding region RC as shown in FIG. 5 or may be located on the right side of the corresponding region RC as shown in FIG. 6.

As described above, the control method in the multi-projection system 100 includes steps S20, S30, S40, S50, and S60.

Here, the first projector 10-1 used for the control method of the embodiment includes the optical device 15 and the processing device 12. The processing device 12 of the first projector 10-1 executes step S20, step S30, step S40, step S50, and step S60. Here, at step S20, the processing device 20 controls the operation of the optical device 15 of the first projector 10-1 and controls the operation of the second projector 10-2 so that the first image group GG1 is projected on the projection surface SC. At step S40, the processing device 12 of the first projector 10-1 controls the operation of the optical device 15 of the first projector 10-1 and controls the operation of the second projector 10-2 so that the second image group GG2 is projected on the projection surface SC.

The control method of the embodiment is realized by the processing device 12 as an example of “computer” executing the program PR1. The program PR1 is for controlling the processing device 12 to execute steps S20, S30, S40, S50, and S60.

In the above described control method, first projector 10-1, and program PR1, in the first state at step S20, the brightness BR1 of the first projection image G1 is greater than zero and the brightness BR2 of the second projection image G2 is zero, and thereby, the first imaging data DI acquired at step S30 contains no noise due to the second projection image G2. Similarly, in the second state at step S40, the brightness BR1 of the first projection image G1 is zero and the brightness BR2 of the second projection image G2 is greater than zero, and thereby, the second imaging data D2 acquired at step S50 contains no noise due to the first projection image G1. As described above, the noise contained in the first imaging data D1 and the second imaging data D2 can be reduced. Thereby, the accuracy of the result of analysis of the first imaging data D1 and the second imaging data D2 at step S60 can be increased. As a result, a decrease in the detection accuracy of the difference in position between the first projection image G1 and the second projection image in the range of the overlapping region R can be suppressed.

As described above, the first projection image G1 includes the non-overlapping region RN1 and the first partial region R1. The non-overlapping region RN1 is the region not overlapping with the second projection image G2. The first partial region R1 is the region to overlap with the second projection image G2. At least a part of the first partial region R1 is the region subjected to blend processing. The blend processing changes the brightness in the arrangement direction DR in which the first projection image G1 and the second projection image G2 are arranged such that the brightness of the overlapping region R when the first projection image G1 and the second projection image G2 are projected to overlap with each other in the overlapping region R may be equal to the brightness of the non-overlapping region RN1. Step S20 includes step S21. Step S21 adjusts the first partial region R1 to include the first state region R1a having the first state and the first blend region R1b to be subjected to the blend processing by changing the blend range in which the blend processing is performed in the first partial region R1 from the first range α to the second range β smaller than the first range. Step S30 includes step S31. At step S31, the imaging device 17 images the first state region R1a. As described above, since the first partial region R1 includes not only the first state region R1a but also the first blend region R1b, even during the period in which the difference in position between the first projection image G1 and the second projection image in the range of the overlapping region R is detected, a seamless composite image can be displayed as a part of the image group GG in the corresponding region RC.

Further, as described above, a brightness distribution in the arrangement direction DR when the blend range is the second range β is different from a brightness distribution in the arrangement direction DR when the blend range is the first range α. Thereby, the brightness distribution can be changed according to the range on which the blend processing is performed in the first partial region R1.

Furthermore, as described above, step S60 includes step S61, step S62, step S63, and step S64. Step S61 extracts the analysis region RAI expressed in the coordinate system of the imaging device 17 from the second imaging data D2. At step S62, the analysis region RA1 is transformed into a region in the coordinate system of the first projector 10-1. At step S63, matching processing is performed on the first partial region R1 as the region of the first projection image G1 to overlap with the second projection image G2, which is expressed in the coordinate system of the first projector 10-1, and the analysis region RA1 transformed into the region in the coordinate system of the first projector 10-1. At step S64, one or both of the amount and direction of the difference in position between the first projection image G1 and the second projection image G2 are detected based on the result of the matching processing. As described above, step S60 includes step S61, step S62, step S63, and step S64, and thereby, the difference in position between the first projection image G1 and the second projection image G2 in the range of the overlapping region R can be preferably detected.

As described above, the control method of the embodiment includes step S70 and step S80. Step S70 calculates the correction amount for correction of one or both of the first projection image G1 and the second projection image G2 based on the detected difference in position. Step S80 controls one or both of the first projector 10-1 and the second projector 10-2 based on the correction amount. In the above described configuration, the difference in position between the first projection image G1 and the second projection image G2 in the range of the overlapping region R can be reduced. Thereby, the image quality of the overlapping region can be increased.

Further, as described above, at step S70, the blend range is maintained in the second range β. That is, the control method of the embodiment includes maintaining the state in which the blend range is the second range β for a first period. In the above described configuration, the change of the blend range can be made less noticeable for the user compared to a case where the first period is not provided. The first period is, for example, 10 seconds, but is not particularly limited as long as the period is set to a finite time.

As described above, the control method of the embodiment includes step S90 and step S110. Step S90 is the step of detecting the temperature of the projection system 15c-1 as an example of “first optical system” for the first projector 10-1 to project the first projection image G1 based on the output from the temperature sensor 18 as an example of one or more “sensors”. The temperature sensor 18 is, for example, a thermistor. When “NO” at step S110, the detection of the difference in position and the correction of the difference in position are intermittently executed until the temperature of the projection system 15c-1 reaches the target temperature based on the output from one or more temperature sensors 18. When “YES” at step S110, the detection of the difference in position and the correction of the difference in position are stopped after the temperature of the projection system 15c-1 reaches the target temperature based on the output from one or more temperature sensors 18. According to steps S90 and S110, the correction of the difference in position can be performed at regular intervals until the temperature of the projection system 15c is stabilized. Thereby, appropriate detection of the difference in position can be timely performed.

### 2. Second Embodiment

As below, a second embodiment of the present disclosure will be described. In the embodiments exemplified as below, the reference signs used in the description of the first embodiment are used for elements having the same actions and functions as those of the first embodiment, and the respective detailed description will be appropriately omitted.

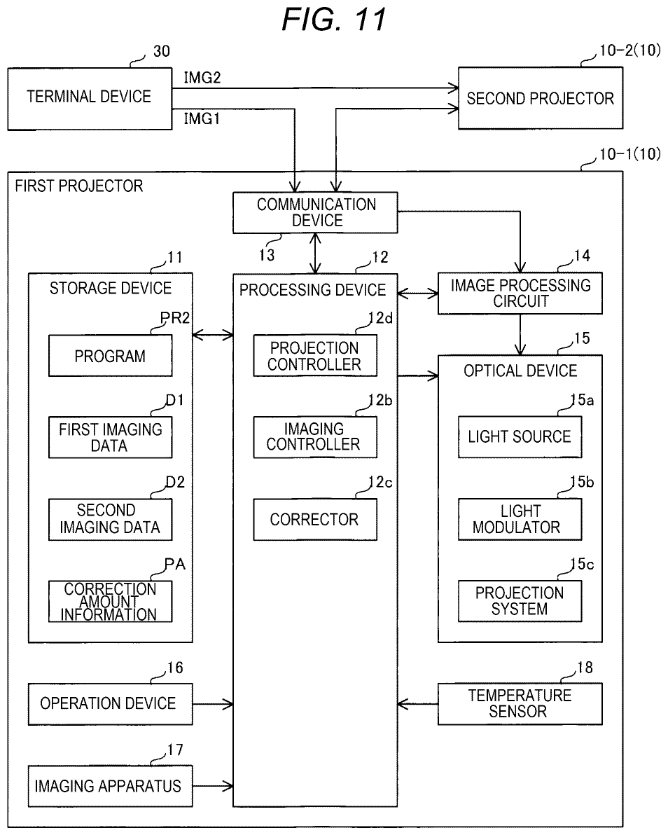

FIG. 11 is a block diagram of a first projector 10-1 according to the second embodiment. The first projector 10-1 of the embodiment has the same configuration as the first projector 10-1 of the first embodiment except that a program PR2 is used instead of the program PR1 of the first embodiment.

In the first projector 10-1 of the embodiment, the processing device 12 functions as a projection controller 12d, the imaging controller 12b, and the corrector 12c by executing the program PR2 stored in the storage device 11.

The projection controller 12d controls the operation of the image processing circuit 14 and the optical device 15 of each of the first projector 10-1 and the second projector 10-2 like the projection controller 12a of the first embodiment except that the blend range is expanded after the projection of the second image group GG2.

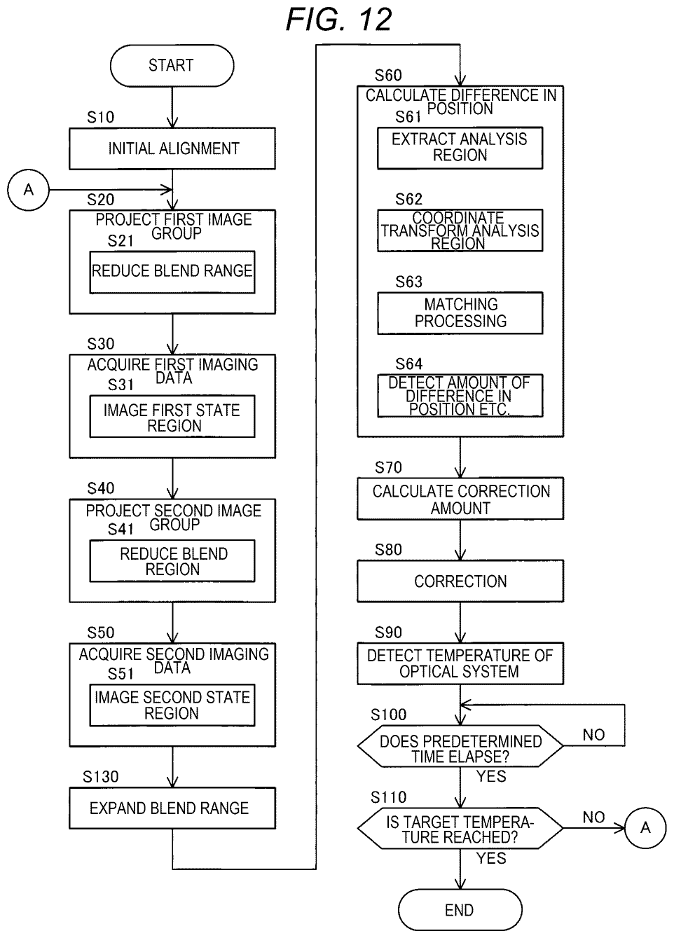

FIG. 12 is a flowchart showing a flow of the control method according to the second embodiment. The control method of the embodiment is the same as the control method of the first embodiment except that step S120 of the first embodiment is omitted and step S130 is added.

Step S130 is executed between step S50 and step S60. At step S130, the projection controller 12d expands the blend range as the range on which the blend processing of the first projection image G1 and the second projection image G2 is performed to the entire of the overlapping region R. That is, at step S130, the projection controller 12d changes the blend range from the second range β to the first range α.

As described above, the control method of the embodiment includes changing the blend range in the first partial region R1 from the second range β to the first range α at step S130.

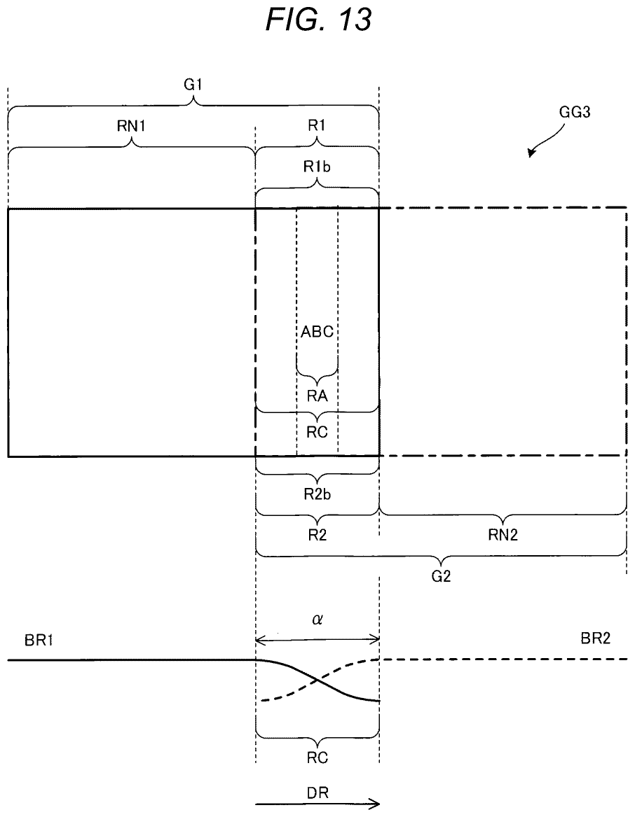

FIG. 13 shows the blend range in a period for calculation of a correction amount. Step S60 to step S110 of the embodiment are executed after execution of the above described step S130. Accordingly, as shown in FIG. 13, the control method of the embodiment includes maintaining the state in which the blend range is the first range α over a period for calculation of the correction amount at step S70. In the example shown in FIG. 13, the first range α is the entire corresponding region RC, but not limited thereto. It is only necessary that the first range α is larger than the second range β.

According to the second embodiment, the image quality in the overlapping region R of the projection image can be increased. As described above, the control method of the embodiment further includes maintaining the state in which the blend range is the first range α over the period for calculation of the correction amount. Accordingly, preferable blend processing can be performed by widening of the blend range in a period other than when necessary. Thereby, the image quality of the overlapping region R can be increased.

### 3. Modified Examples

The respective embodiments exemplified as above can be variously modified. Specific modified configurations applicable to the above described respective embodiments will be exemplified as below. Two or more configurations optionally selected from the following exemplifications can be combined as appropriate as long as the configurations are mutually consistent.

### 3-1. Modified Example 1

In the above described embodiments, the configuration in which the blend processing is performed is exemplified, however, the present disclosure is not limited to the configuration. The first blend region R1b and the second blend region R2b may be omitted.

### 3-2. Modified Example 2

In the above described embodiments, the configuration in which the first imaging data D1 and the second imaging data D2 are acquired using the imaging device 17 of the first projector 10-1 is exemplified, however, the present disclosure is not limited to the configuration. For example, the acquisition of the first imaging data D1 and the second imaging data D2 may be performed using the imaging device 17 of the second projector 10-2 instead of the imaging device 17 of the first projector 10-1, or in addition to the imaging device 17 of the first projector 10-1.

### 3-3. Modified Example 3

At step S70 of the above described embodiment, the first projector 10-1 calculates the correction amount for correction of the first projection image G1 based on the difference in position detected at step S60, however, the present disclosure is not limited to the configuration. For example, the second projector 10-2 may have a correction function and, at step S70, the second projector 10-2 may calculate a correction amount for correction of the second projection image G2 based on the difference in position detected at step S60, and the drawn image of the light modulator 15b of the second projector 10-2 may be corrected based on the correction amount. Alternatively, at step S70, both the first projector 10-1 and the second projector 10-2 may have the correction functions, and both the first projector 10-1 and the second projector 10-2 may be calculate the correction amounts for correction of the second projection image G2 based on the difference in position detected at step S60. The correction amounts when both the first projector 10-1 and the second projector 10-2 have the correction functions are preferably halves of the correction amount when only one of the first projector 10-1 and the second projector 10-2 has the correction function. Alternatively, when the first projector 10-1 may calculate the correction amount for correction of the first projection image G1, the drawn image of the light modulator 15b of the second projector 10-2 may be corrected based on the correction amount. In this case, it is preferable to convert the correction amount for the first projector 10-1 to correct the first projection image G1 into the correction amount for the second projector 10-2 to correct the drawn image of the light modulator 15b of the second projector 10-2, for example, by inverting the sign of the correction amount calculated by the first projector 10-1.

A part or all of the method of the present disclosure including the calculation of the correction amount may be performed by each of the terminal device 30, the processing device 12, and the processing device of the second projector 10-2 having the same function as the processing device 12, or the devices may share each step provided in the method of the present disclosure.

### 3-4. Modified Example 4

At step S80 of the above described embodiment, the first projector 10-1 is controlled based on the correction amount calculated at step S70, however, the present disclosure is not limited to this aspect. For example, the second projector 10-2 may have a correction function, correction amount information PA may be transmitted from the first projector 10-1 to the second projector 10-2, and the second projector 10-2 may be controlled based on the correction amount information PA. In this case, the correction of the image group GG is performed by adjustment of the positions of the first projection image G1 and the second projection image G2.

### 3-5. Modified Example 5

At least one of the program PR1 of the first embodiment and the program PR2 of the second embodiment may be recorded in a computer-readable and non-transitory storage medium and provided. The computer is, for example, the processing device 12 or the terminal device 30. At least one of the program PR1 of the first embodiment and the program PR2 of the second embodiment may be downloaded from a server to a computer through a network and provided.

### 3-6. Modified Example 6

The first projector 10-1 of the first embodiment includes the storage device 11, the processing device 12, the communication device 13, the image processing circuit 14, the optical device 15, the operation device 16, the imaging device 17, and the temperature sensor 18, however, the present disclosure is not limited to the configuration. For example, the first projector 10-1 may include the storage device 11, the processing device 12, the communication device 13, the image processing circuit 14, the optical device 15, and the operation device 16, but may not include the imaging device 17 and the temperature sensor 18. That is, the imaging device 17 and the temperature sensor 18 may be communicable with the first projector 10-1 and separated from the first projector 10-1. The same applies to the second projector 10-2.

### 3-7. Modified Example 7

When “YES” at step S110 of the first embodiment, after one or both of the temperature of the projection system 15c-1 and the temperature of the projection system 15c-2 reach the target temperature based on the output from the one or more temperature sensors 18, the processing device 12 stops the detection of the difference in position and the correction of the difference in position, however, the present disclosure is not limited to the configuration. For example, the processing device 12 may stop the detection of the difference in position and the correction of the difference in position when an elapsed time from the start of the detection of the difference in position and the correction of the difference in position exceeds a target time. For example, when the correction amount becomes equal to or less than a predetermined value, the processing device 12 may stop the detection of the difference in position and the correction of the difference in position.

### 3-8. Modified Example 8

The brightness BR1 of the first embodiment changes smoothly in the first blend region R1b, however, the present disclosure is not limited to the configuration. For example, the brightness BR1 of the first embodiment may have a stepwise change in the first blend region R1b. The brightness BR1 of the first embodiment may not include the first blend region R1b. That is, the brightness BR1 of Embodiment 1 may change stepwise.

### 3-9. Modified Example 9

In the first embodiment, the matching processing for calculating the difference in position between the first projection image G1 and the second projection image G2 is performed as calculation exclusively in the coordinate system of the light modulator 15b (first drawing panel) of the first projector 10-1, however, the present disclosure is not limited to the configuration. For example, the matching processing may be performed as calculation exclusively in the coordinate system of the imaging device 17. In this case, the difference in position between the first projection image G1 and the second projection image G2 in the coordinate system of the imaging device 17 may be transformed into a difference in position in the coordinate system of the light modulator 15b of the first projector 10-1 based on the correlation obtained at step S10.

### 3-10. Modified Example 10

At step S90 of the first embodiment, the temperature of the projection system 15c-1 is detected based on the output from the temperature sensor 18, however, the present disclosure is not limited to the configuration. For example, at step S90, the temperature of the projection system 15c-2 may be detected, or both the temperature of the projection system 15c-1 and the temperature of the projection system 15c-2 may be detected. That is, at step S90, at least one of the temperature of the projection system 15c-1 and the temperature of the projection system 15c-2 may be detected.

Similarly, at step S110 of the first embodiment, whether the temperature of the projection system 15c-1 reaches the target temperature is determined, however, the present disclosure is not limited to the configuration. For example, at step S110, whether the temperature of the projection system 15c-2 reaches the target temperature may be determined, or whether both the temperature of the projection system 15c-1 and the temperature of the projection system 15c-2 reach the target temperature may be determined. That is, at step S110, whether at least one of the temperature of the projection system 15c-1 and the temperature of the projection system 15c-2 reaches the target temperature may be determined.

### 4. Appendices

As below, the summary of the present disclosure will be appended.

(Appendix 1) A control method having a first configuration as a preferred example of the present disclosure is a control method in a multi-projection system in which an overlapping region where a part of a first projection image projected from a first projector overlaps with a part of a second projection image projected from a second projector on a projection surface is set, and the control method includes projecting a first image group having a first state in which brightness of the first projection image is greater than zero and brightness of the second projection image is zero on the projection surface in a corresponding region corresponding to the overlapping region, acquiring first imaging data by imaging the corresponding region with the first image group projected on the projection surface, projecting a second image group having a second state in which the brightness of the first projection image is zero and the brightness of the second projection image is greater than zero on the projection surface in the corresponding region, acquiring second imaging data by imaging the corresponding region with the second image group projected on the projection surface, and detecting a difference in position between the first projection image and the second projection image in a range of the overlapping region by analyzing the first imaging data and the second imaging data.

In the above described configuration, in the first state, the brightness of the first projection image is greater than zero and the brightness of the second projection image is zero, and thereby, the first imaging data contains no noise due to the second projection image in the region where the brightness of the second projection image is zero. Similarly, the second imaging data contains no noise due to the first projection image in the region where the brightness of the first projection image is zero. As described above, the control method can create a region where the noise contained in the first imaging data and the second imaging data is reduced. Thereby, the accuracy of the result of analysis of the first imaging data and the second imaging data can be increased. As a result, a decrease in the detection accuracy of the difference in position between the first projection image and the second projection image in the range of the overlapping region can be suppressed.

(Appendix 2) In a second configuration as a preferred example of the first configuration, the first projection image has a non-overlapping region as a region not overlapping with the second projection image and a first partial region to overlap with the second projection image, at least a part of the first partial region is a region where blend processing of changing brightness in an arrangement direction in which the first projection image and the second projection image are arranged is performed to equalize brightness in the overlapping region when the first projection image and the second projection image are projected to overlap with each other in the overlapping region to brightness in the non-overlapping region, projecting the first image group on the projection surface includes adjusting the first partial region to contain a first state region having the first state and a first blend region on which the blend processing is performed by changing a blend range on which the blend processing is performed in the first partial region from a first range to a second range smaller than the first range, and acquiring the first imaging data includes imaging the first state region. In the above described configuration, since the first partial region includes not only the region in the first state but also the first blend region, a seamless composite image can be displayed in the corresponding region even during the period in which the difference in position between the first projection image and the second projection image in the range of the overlapping region is detected.

(Appendix 3) In a third configuration as a preferred example of the second configuration, a brightness distribution in the arrangement direction when the blend range is the second range is different from a brightness distribution in the arrangement direction when the blend range is the first range. In the above described configuration, the brightness distribution can be changed according to the range on which the blend processing is performed in the first partial region.

(Appendix 4) In a fourth configuration as a preferred example of any one of the first configuration to the third configuration, detecting the difference in position between the first projection image and the second projection image in the range of the overlapping region includes extracting an analysis region expressed in a coordinate system of an imaging device from the second imaging data, generating transformed data obtained by transformation of the analysis region into a region in a coordinate system of a drawing panel of the first projector, performing matching processing on drawing data representing the region corresponding to the analysis region in the first projection image and expressed in the coordinate system of the drawing panel and the transformed data, and detecting one or both of an amount and a direction of the difference in position between the first projection image and the second projection image based on a result of the matching processing. In the above described configuration, the difference in position between the first projection image and the second projection image in the range of the overlapping region can be preferably detected.

(Appendix 5) In a fifth configuration as a preferable example of the second configuration or the third configuration, the control method further includes calculating a correction amount for correction of one or both of the first projection image and the second projection image based on the detected difference in position, and controlling one or both of the first projector and the second projector based on the correction amount. In the above described configuration, the difference in position between the first projection image and the second projection image in the range of the overlapping region can be reduced. Thereby, the image quality of the overlapping region can be increased.

(Appendix 6) In a sixth configuration as a preferred example of the fifth configuration, the control method further includes changing the blend range from the second range to the first range in the first partial region, and maintaining a state in which the blend range is the first range for a first period. In the above described configuration, a relatively wide blend range is set in the first period as a period other than when necessary, and thereby, the preferable blend processing for the user can be performed. Thereby, the image quality of the overlapping region can be increased.

(Appendix 7) In a seventh configuration as a preferable example of the fifth configuration or the sixth configuration, a state in which the blend range is the second range is maintained for a first period. In the above described configuration, the first period is provided as a period for maintaining the state in which the blend range is the second range, and thereby, a change of the blend range can be made less noticeable.

(Appendix 8) In an eighth configuration as a preferred example of any one of the fifth configuration to the seventh configuration, the control method further includes detecting a temperature of a first optical system for the first projector to project the first projection image based on output from one or more sensors, intermittently executing the detection of the difference in position and the correction of the difference in position until the temperature of the first optical system reaches a target temperature based on the output from the one or more sensors, and stopping the detection of the difference in position and the correction of the difference in position after the temperature of the first optical system reaches the target temperature based on the output from the one or more sensors. In the above described configuration, the correction of the difference in position can be performed at regular intervals until the temperatures of the first optical system and the second optical system are stabilized. Thereby, appropriate detection of the difference in position can be timely performed.

(Appendix 9) A projector having a ninth configuration as a preferred example of the present disclosure is a projector used as a first projector in a multi-projection system in which an overlapping region for a part of a first projection image projected from the first projector and a part of a second projection image projected from a second projector to overlap with each other on a projection surface is set, the projector includes an optical device, and a processing device, and the processing device executes controlling an operation of the optical device and controlling an operation of the second projector to project a first image group having a first state in which brightness of the first projection image is greater than zero and brightness of the second projection image is zero on the projection surface in a corresponding region corresponding to the overlapping region, acquiring first imaging data by an imaging device imaging the corresponding region with the first image group projected on the projection surface, controlling the operation of the optical device and controlling the operation of the second projector to project a second image group having a second state in which the brightness of the first projection image is zero and the brightness of the second projection image is greater than zero on the projection surface in the corresponding region, acquiring second imaging data by the imaging device imaging the corresponding region with the second image group projected on the projection surface, and detecting a difference in position between the first projection image and the second projection image in a range of the overlapping region by analyzing the first imaging data and the second imaging data.

In the above described configuration, in the first state, the brightness of the first projection image is greater than zero and the brightness of the second projection image is zero, and thereby, the first imaging data contains no noise due to the second projection image. Similarly, the second imaging data contains no noise due to the first projection image. As described above, the noise contained in the first imaging data and the second imaging data can be reduced. Thereby, the accuracy of the result of analysis of the first imaging data and the second imaging data can be increased. As a result, a decrease in the detection accuracy of the difference in position between the first projection image and the second projection image in the range of the overlapping region can be suppressed.

(Appendix 10) In a non-transitory computer-readable storage medium storing a program having a tenth configuration as a preferred example of the present disclosure, the program is used in a multi-projection system in which an overlapping region for a part of a first projection image projected from a first projector and a part of a second projection image projected from a second projector to overlap with each other on a projection surface is set, and the program is used for controlling a computer to execute projecting a first image group having a first state in which brightness of the first projection image is greater than zero and brightness of the second projection image is zero on the projection surface in a corresponding region corresponding to the overlapping region, acquiring first imaging data by an imaging device imaging the corresponding region with the first image group projected on the projection surface, projecting a second image group having a second state in which the brightness of the first projection image is zero and the brightness of the second projection image is greater than zero on the projection surface in the corresponding region, acquiring second imaging data by the imaging device imaging the corresponding region with the second image group projected on the projection surface, and detecting a difference in position between the first projection image and the second projection image in a range of the overlapping region by analyzing the first imaging data and the second imaging data.

In the above described configuration, in the first state, the brightness of the first projection image is greater than zero and the brightness of the second projection image is zero, and thereby, the first imaging data contains no noise due to the second projection image. Similarly, the second imaging data contains no noise due to the first projection image. As described above, the noise contained in the first imaging data and the second imaging data can be reduced. Thereby, the accuracy of the result of analysis of the first imaging data and the second imaging data can be increased. As a result, a decrease in the detection accuracy of the difference in position between the first projection image and the second projection image in the range of the overlapping region can be suppressed.

What is claimed is:

1. A control method in a multi-projection system in which an overlapping region is set, the overlapping region being a region in which a part of a first projection image projected from a first projector overlaps with a part of a second projection image projected from a second projector on a projection surface, the control method comprising:
projecting a first image group having a first state in which brightness of the first projection image is greater than zero and brightness of the second projection image is zero on the projection surface in a corresponding region corresponding to the overlapping region;
acquiring first imaging data by imaging the corresponding region with the first image group projected on the projection surface;
projecting a second image group having a second state in which the brightness of the first projection image is zero and the brightness of the second projection image is greater than zero on the projection surface in the corresponding region;
acquiring second imaging data by imaging the corresponding region with the second image group projected on the projection surface; and
detecting a difference in position between the first projection image and the second projection image in a range of the overlapping region by analyzing the first imaging data and the second imaging data.

2. The control method according to claim 1, wherein
the first projection image has a non-overlapping region as a region not overlapping with the second projection image and a first partial region to overlap with the second projection image,
at least a part of the first partial region is a region where blend processing of changing brightness in an arrangement direction in which the first projection image and the second projection image are arranged is performed to equalize brightness in the overlapping region when the first projection image and the second projection image are projected to overlap with each other in the overlapping region to brightness in the non-overlapping region,
projecting the first image group on the projection surface includes adjusting the first partial region to contain a first state region having the first state and a first blend region on which the blend processing is performed by changing a blend range on which the blend processing is performed in the first partial region from a first range to a second range smaller than the first range, and
acquiring the first imaging data includes imaging the first state region.

3. The control method according to claim 2, wherein
a brightness distribution in the arrangement direction when the blend range is the second range is different from a brightness distribution in the arrangement direction when the blend range is the first range.

4. The control method according to claim 1, wherein detecting the difference in position between the first projection image and the second projection image in the range of the overlapping region includes:
extracting an analysis region expressed in a coordinate system of an imaging device from the second imaging data;
generating transformed data obtained by transformation of the analysis region into a region in a coordinate system of a drawing panel of the first projector;
performing matching processing on drawing data representing the region corresponding to the analysis region in the first projection image and expressed in the coordinate system of the drawing panel and the transformed data, and detecting one or both of an amount and a direction of the difference in position between the first projection image and the second projection image based on a result of the matching processing.

5. The control method according to claim 2, further comprising:
calculating a correction amount for correction of one or both of the first projection image and the second projection image based on the detected difference in position; and
controlling one or both of the first projector and the second projector based on the correction amount.

6. The control method according to claim 5, further comprising:
changing the blend range from the second range to the first range in the first partial region; and
maintaining a state in which the blend range is the first range for a first period.

7. The control method according to claim 5, further comprising maintaining a state in which the blend range is the second range for a first period.

8. The control method according to claim 5, further comprising:
detecting a temperature of a first optical system for the first projector to project the first projection image based on output from one or more sensors;
intermittently executing the detection of the difference in position and the correction of the difference in position until the temperature of the first optical system reaches a target temperature based on the output from the one or more sensors; and
stopping the detection of the difference in position and the correction of the difference in position after the temperature of the first optical system reaches the target temperature based on the output from the one or more sensors.

9. A projector used as a first projector in a multi-projection system in which an overlapping region is set, the overlapping region being a region in which a part of a first projection image projected from the first projector and a part of a second projection image projected from a second projector to overlap with each other on a projection surface, the projector comprising:
an optical device; and
one or more processors configured to:
control an operation of the optical device and control an operation of the second projector to project a first image group having a first state in which brightness of the first projection image is greater than zero and brightness of the second projection image is zero on the projection surface in a corresponding region corresponding to the overlapping region,
acquire first imaging data by an imaging device imaging the corresponding region with the first image group projected on the projection surface,
control the operation of the optical device and control the operation of the second projector to project a second image group having a second state in which the brightness of the first projection image is zero and the brightness of the second projection image is greater than zero on the projection surface in the corresponding region, acquire second imaging data by the imaging device imaging the corresponding region with the second image group projected on the projection surface, and
detect a difference in position between the first projection image and the second projection image in a range of the overlapping region by analyzing the first imaging data and the second imaging data.

10. A non-transitory computer-readable storage medium storing a program used in a multi-projection system in which an overlapping region is set, the overlapping region being a region in which a part of a first projection image projected from a first projector and a part of a second projection image projected from a second projector to overlap with each other on a projection surface, the program used for controlling a computer to execute:
projecting a first image group having a first state in which brightness of the first projection image is greater than zero and brightness of the second projection image is zero on the projection surface in a corresponding region corresponding to the overlapping region;
acquiring first imaging data by an imaging device imaging the corresponding region with the first image group projected on the projection surface;
projecting a second image group having a second state in which the brightness of the first projection image is zero and the brightness of the second projection image is greater than zero on the projection surface in the corresponding region;
acquiring second imaging data by the imaging device imaging the corresponding region with the second image group projected on the projection surface; and
detecting a difference in position between the first projection image and the second projection image in a range of the overlapping region by analyzing the first imaging data and the second imaging data.
